(19) United States
(12) Patent Application Publication
(10) Pub. No.: US 2025/0137388 A1
(43) Pub. Date: May 1, 2025

(54) TURBINE

(71) Applicant: IHI Corporation, Tokyo (JP)

(72) Inventor: Hideto KAWANA, Tokyo (JP)

(73) Assignee: IHI Corporation, Tokyo (JP)

(21) Appl. No.: 19/010,266

(22) Filed: Jan. 6, 2025

Related U.S. Application Data
(63) Continuation of application No. PCT/JP2023/015192, filed on Apr. 14, 2023.

(30) Foreign Application Priority Data
Sep. 7, 2022 (JP) 2022-142055

(51) Int. Cl. F01D 25/24; F01D 9/02; F01D 17/14

(52) U.S. Cl. CPC F01D 25/24; F01D 9/026; F01D 17/145; F05D 2220/40; F05D 2250/15

(57) ABSTRACT

A turbine includes an impeller, and a housing that accommodates the impeller, the housing including an inlet that fluidly communicates with an exhaust port of an engine, a first space that accommodates the impeller, a second space that is located downstream of the first space in a flow of exhaust gas from the engine, a first flow path that connects the inlet to the first space, and a second flow path that directly connects the inlet to the second space without connecting the inlet to the first space.

### CROSS REFERENCE TO RELATED APPLICATIONS

This application is a continuation application of International Application No. PCT/JP2023/015192, filed on Apr. 14, 2023, which claims priority to Japanese Patent Application No. 2022-142055 filed on Sep. 7, 2022, the entire contents of which are incorporated herein by reference.

### BACKGROUND ART

### Technical Field

The present disclosure relates to a turbine.

A turbine may be arranged in an exhaust flow path of an engine. An impeller of the turbine is rotated by exhaust gas from the engine. For example, a rotational force of the impeller is used by another device such as a compressor to pressurize intake air for the engine.

Furthermore, a catalyst may be provided in the exhaust flow path to purify the exhaust gas. When the engine is started, the catalyst is at ambient temperature. The catalyst must be heated above a certain temperature to function well. Accordingly, the turbine may include a bypass flow path so that a part of the exhaust gas bypasses the impeller. During engine startup, a valve in the bypass flow path is opened so that the part of the exhaust gas flows into the catalyst without passing through the impeller. According to such a configuration, the temperature of the exhaust gas bypassing the impeller does not decrease, so that the catalyst is heated quickly.

Patent Literature 1 discloses a turbine including such a bypass flow path. The turbine includes two scroll flow paths. Each of the two scroll flow paths fluidly communicates with a turbine wheel. One of the two scroll flow paths is connected to the bypass flow path. The bypass flow path connects the corresponding scroll flow pass to a space downstream of the turbine wheel. According to such a configuration, a part of exhaust gas flows into the space downstream of the turbine wheel without passing through the turbine wheel. In this space, a sliding valve is provided to open and close the bypass flow path.

### CITATION LIST

### Patent Literature

Patent Literature 1: JP 2017-141704 A

### SUMMARY

### Technical Problem

In the turbine of Patent Literature 1, the valve in the bypass flow path may obstruct a main flow passing through the impeller and a bypass flow. Accordingly, the exhaust gas may not be efficiently directed to the catalyst.

The purpose of the present disclosure is to provide a turbine that can smoothly direct exhaust gas.

### Solution to Problem

In order to solve the above problem, a turbine according to one aspect of the present disclosure includes an impeller, and a housing that accommodates the impeller, the housing including an inlet that fluidly communicates with an exhaust port of an engine, a first space that accommodates the impeller, a second space that is located downstream of the first space in a flow of exhaust gas from the engine, a first flow path that connects the inlet to the first space, and a second flow path that directly connects the inlet to the second space without connecting the inlet to the first space.

The turbine may include a valve that opens and closes the second flow path at a position upstream of the first space.

The volume of the second flow path may be smaller than the volume of the first flow path.

The second flow path may have a spiral shape.

The turbine may include an exhaust opening that is located downstream of the second space in the flow of the exhaust gas, and the second flow path may be configured to face the exhaust opening in an axial direction of the impeller.

### Effects

According to the present disclosure, exhaust gas can be smoothly directed.

### BRIEF DESCRIPTION OF DRAWINGS

FIG. 1 is a schematic cross-sectional view of a turbocharger including a turbine according to an embodiment.

FIG. 2 is a schematic front view of the turbocharger seen in a direction indicated by arrow II in FIG. 1.

FIG. 3 is a partial perspective view of an area enclosed by dashed lines in FIG. 2.

### DESCRIPTION OF EMBODIMENTS

An embodiment of the present disclosure will be described in detail below with reference to the accompanying drawings. Specific dimensions, materials, and numerical values described in the embodiment are merely examples for a better understanding, and do not limit the present disclosure unless otherwise specified. In this specification and the drawings, duplicate explanations are omitted for elements having substantially the same functions and configurations by assigning the same sign. Furthermore, elements not directly related to the present disclosure are omitted from the figures.

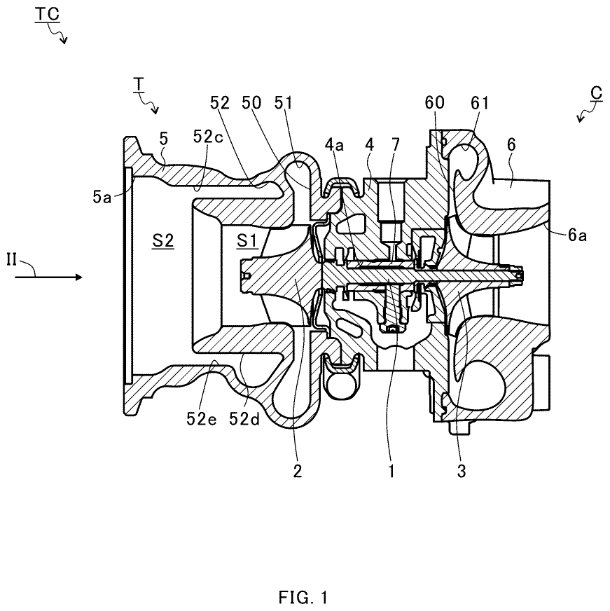

FIG. 1 is a schematic cross-sectional view of a turbocharger TC including a turbine T according to an embodiment. In the present embodiment, the turbine T is incorporated into the turbocharger TC. In another embodiment, the turbine T may be incorporated into a device other than the turbocharger TC, or may be a stand-alone unit.

The turbocharger TC includes a shaft 1, a turbine impeller (impeller) 2, and a compressor impeller 3. As described later, the shaft 1, the turbine impeller 2, and the compressor impeller 3 rotate integrally. Accordingly, in the present disclosure, “axial directions,” “radial directions,” and “circumferential directions” of the shaft 1, the turbine impeller 2, and the compressor impeller 3 may simply be referred to as an “axial direction,” a “radial direction,” and a “circumferential direction,” respectively.

The turbocharger TC includes a bearing housing 4, a turbine housing (housing) 5, and a compressor housing 6. The turbine housing 5 is connected to a first end face (left end face in FIG. 1) of the bearing housing 4 in the axial direction. The compressor housing 6 is connected to a second end face (right end face in FIG. 1) of the bearing housing 4 in the axial direction.

The bearing housing 4 includes a bearing hole 4a. The bearing hole 4a extends in the axial direction in the bearing housing 4. The bearing hole 4a accommodates a bearing 7. In the present embodiment, a semi-floating bearing is shown as an example of the bearing 7. In another embodiment, the bearing 7 may be other radial bearing such as a full floating bearing or a rolling bearing. The bearing 7 rotatably supports the shaft 1.

The turbine impeller 2 is provided at a first end (left end in FIG. 1) of the shaft 1 in the axial direction. The turbine impeller 2 rotates integrally with the shaft 1. The turbine impeller 2 is rotatably accommodated in the turbine housing 5.

The compressor impeller 3 is provided at a second end (right end in FIG. 1) that is opposite to the first end of the shaft 1 in the axial direction. The compressor impeller 3 rotates integrally with the shaft 1. The compressor impeller 3 is rotatably accommodated in the compressor housing 6.

The compressor housing 6 includes an intake opening 6a on an end face that is opposite to the bearing housing 4 in the axial direction. The intake opening 6a is connected to an air cleaner (not shown). The bearing housing 4 and the compressor housing 6 define a diffuser flow path 60 therebetween. The diffuser flow path 60 has an annular shape around the compressor impeller 3. The diffuser flow path 60 fluidly communicates with the intake opening 6a through the compressor impeller 3.

The compressor housing 6 includes a scroll flow path 61. The scroll flow path 61 is located radially outside with respect to the diffuser flow path 60. The scroll flow path 61 fluidly communicates with the diffuser flow path 60. Furthermore, the scroll flow path 61 fluidly communicates with an intake port of an engine (not shown). The Scroll flow path 61 has a substantially spiral shape.

In the compressor housing 6 as described above, air is sucked into the compressor housing 6 from the intake opening 6a when the compressor impeller 3 rotates. The air is accelerated and pressurized by centrifugal force while passing through the compressor impeller 3. The air is further pressurized in the diffuser flow path 60 and the scroll flow path 61. The pressurized air flows out of an outlet (not shown), and is directed to the intake port of the engine. In the turbocharger TC, a portion including the compressor impeller 3 and the compressor housing 6 functions as a centrifugal compressor C.

The turbine housing 5 includes an exhaust opening 5a on an end face that is opposite to the bearing housing 4 in the axial direction. The exhaust opening 5a is connected to an exhaust gas purifier (not shown). For example, the exhaust gas purifier includes a catalyst. Generally, the catalyst is at ambient temperature when the engine is started. When heated above a certain temperature, the catalyst purifies exhaust gas well.

The turbine housing 5 includes a connecting flow path 50. The connecting flow path 50 has an annular shape around the turbine impeller 2. The connecting flow path 50 fluidly communicates with the exhaust opening 5a through the turbine impeller 2.

The turbine housing 5 includes a first scroll flow path (first flow path) 51. The first scroll flow path 51 is located radially outside with respect to the connecting flow path 50. The first scroll flow path 51 has a substantially spiral shape. The first scroll flow path 51 is connected to the connecting flow path 50.

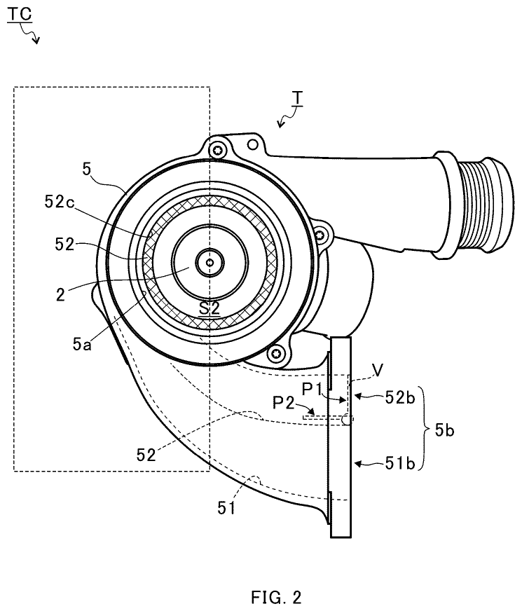

FIG. 2 is a schematic front view of the turbocharger TC seen in a direction indicated by arrow II in FIG. 1. The turbine housing 5 includes an inlet 5b of exhaust gas. The inlet 5b fluidly communicates with an exhaust port of the engine (not shown). The inlet 5b receives exhaust gas discharged from the engine. The inlet 5b includes a first inlet 51b and a second inlet 52b. For example, one exhaust pipe may be connected to both the first inlet 51b and the second inlet 52b. In another embodiment, a part of a plurality of exhaust manifolds may be connected to the first inlet 51b, and the rest of the exhaust manifolds may be connected to the second inlet 52b. The first scroll flow path 51 is connected to the first inlet 51b.

The turbine housing 5 includes a second scroll flow path (second flow path) 52. The second scroll flow path 52 will be described in detail later.

During normal operation of the engine, exhaust gas is led from the exhaust port of the engine to the first scroll flow path 51 through the first inlet 51b. Referring to FIG. 1, furthermore, the exhaust gas is led from the first scroll flow path 51 to the exhaust opening 5a through the connecting flow path 50 and the turbine impeller 2. The exhaust gas rotates the turbine impeller 2 while passing through the turbine impeller 2. The rotational force of the turbine impeller 2 is transmitted to the compressor impeller 3 through the shaft 1. As the compressor impeller 3 rotates, air is suck into the intake opening 6a and is accelerated and pressurized by the compressor impeller 3, as described above. In the turbocharger TC, a portion including the turbine impeller 2 and the turbine housing 5 functions as the turbine T.

Next, the second scroll flow path 52 in the turbine housing 5 will be described.

The turbine housing 5 includes a first space S1 that accommodates the turbine impeller 2. The turbine housing 5 also includes a second space S2 located downstream of the first space S1 in a flow of the exhaust gas. Specifically, the second space S2 is located between the first space S1 and the exhaust opening 5a.

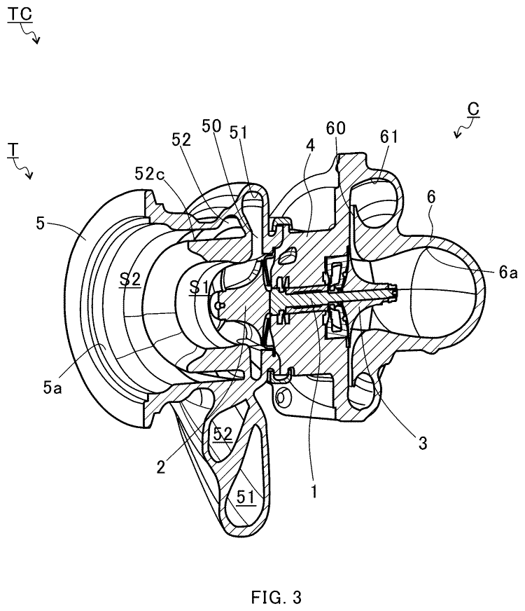

FIG. 3 is a partial perspective view of an area enclosed by dashed lines in FIG. 2. Referring to FIGS. 2 and 3, the second scroll flow path 52 has a substantially spiral shape in the present embodiment. In another embodiment, the second flow path may have other shapes such as an annular shape or a linear shape, as long as the second flow path directly connects the second inlet 52b to the second space S2 without connecting the second inlet 52b to the first space S1, as described later. Referring to FIG. 2, one end of the second scroll flow path 52 is connected to the second inlet 52b.

A valve V is provided at the second inlet 52b. The valve V opens and closes the second scroll flow path 52 based on commands from a controller (not shown). A position P1 represents a closed position where the valve V closes the second scroll flow path 52. A position P2 represents an open position where the valve V opens the second scroll flow path 52. The valve V is not limited to that shown in FIG. 2, and may have other configurations. A similar valve may also be provided at the first inlet 51b to open and close the first scroll flow path 51.

Referring to FIG. 3, the other end of the second scroll flow path 52 is connected to the second space S2. The second scroll flow path 52 includes an outlet 52c that opens into the second space S2. Referring to FIG. 2, in the present embodiment, the outlet 52c (cross-hatched area in FIG. 2) has a circular shape when seen in the axial direction, and is continuous in the circumferential direction. In another embodiment, the outlet 52c may not be continuous in the circumferential direction, and may be partly provided in the circumferential direction. For example, the second scroll flow path 52 may include a plurality of outlets arranged along the circumferential direction.

Referring to FIG. 1, the second scroll flow path 52 is not connected to the first space S1. In other words, the second scroll flow path 52 does not connect the second inlet 52b to the first space S1, but directly connects the second inlet 52b to the second space S2. The second scroll flow path 52 is formed radially outside with respect to the first space S1 across a wall, and includes a portion extending in an annular shape or a cylindrical shape.

The outlet 52c of the second scroll flow path 52 faces the exhaust opening 5a in the axial direction. According to such a configuration, the direction of a flow of exhaust gas flowing from the second scroll flow path 52 into the second space S2 is directed toward the exhaust opening 5a. Specifically, in the present embodiment, an inner circumferential surface 52d of the second scroll flow path 52 extends parallel to the axial direction in an area including the outlet 52c. Furthermore, in the present embodiment, an outer circumferential surface 52e of the second scroll flow path 52 extends parallel to the axial direction in the area including the outlet 52c. These configurations make the direction of the flow of the exhaust gas flowing from the second scroll flow path 52 into the second space S2 substantially parallel to the axial direction. In another embodiment, at least one of the inner circumferential surface 52d and the outer circumferential surface 52e may be inclined with respect to the axial direction in the area including the outlet 52c.

Referring to FIG. 3, the volume of the second scroll flow path 52 is smaller than the volume of the first scroll flow path 51.

Next, the function of the second scroll flow path 52 will be described.

Referring to FIG. 2, for example, the valve V is opened when the engine is started. This opens the second scroll flow path 52. A part of the exhaust gas flows into the second scroll flow path 52 through the second inlet 52b. Referring to FIG. 1, the exhaust gas flows out of the second scroll flow path 52 directly into the second space S2 without passing through the turbine impeller 2. Since the temperature of the exhaust gas bypassing the turbine impeller 2 does not decrease, hotter exhaust gas is supplied to the exhaust gas purifier, compared to the case in which the second scroll flow path 52 is not used. Accordingly, the catalyst can be heated quickly when the engine is started.

Furthermore, in the present embodiment, the second scroll flow path 52 is not connected to the first space S1 and only connected to the second space S2. Accordingly, a part of the exhaust gas can be efficiently directed to the second space S2. In addition, the second space S2 is not provided with a valve to open and close the second scroll flow path 52. Accordingly, a bypass flow flowing out of the second scroll flow path 52 and a main flow passing through the turbine impeller 2 are not obstructed by the valve. Accordingly, the exhaust gas can be directed smoothly.

Furthermore, in the present embodiment, the outlet 52c of the second scroll flow path 52 faces the exhaust opening 5a in the axial direction. According to such a configuration, the direction of the exhaust gas flowing from the second scroll flow path 52 into the second space S2 is directed toward the exhaust opening 5a. Accordingly, the bypass flow smoothly merges with the main flow. Accordingly, the exhaust gas can be directed more smoothly.

As described above, the turbine T includes the turbine impeller 2 and the turbine housing 5 that accommodates the turbine impeller 2. The turbine housing 5 includes the inlet 5b that fluidly communicates with the exhaust port of the engine, the first space S1 that accommodates the turbine impeller 2, the second space S2 that is located downstream of the first space S1 in the flow of the exhaust gas from the engine, the first scroll flow path 51 that connects the inlet 5b to the first space S1, and the second scroll flow path 52 that directly connects the inlet 5b to the second space S2 without connecting the inlet 5b to the first space S1. According to such a configuration, the second scroll flow path 52 is not connected to the first space S1 and only connected to the second space S2. Accordingly, a part of the exhaust gas can be efficiently directed to the second space S2. Furthermore, the second space S2 is not provided with a valve to open and close the second scroll flow path 52. Accordingly, the bypass flow and the main flow flowing through the turbine impeller 2 are not obstructed by the valve. Accordingly, the exhaust gas can be directed smoothly.

Furthermore, in the above embodiment, the turbine T includes the valve V that opens and closes the second scroll flow path 52 at a position upstream of the first space S1. According to such a configuration, the valve V must be provided at least at the inlet 5b or at a position upstream of the inlet 5b. Accordingly, the exhaust gas does not accumulate in the second scroll flow path 52 when the valve V is closed during the normal operation of the engine. As such, the exhaust gas can be directed smoothly during the normal operation.

Furthermore, in the above embodiment, the volume of the second scroll flow path 52 is smaller than the volume of the first scroll flow path 51. When the engine is started, the rotational rate of the engine is low. Accordingly, the volume of the exhaust gas led to the second scroll flow path 52 during the engine startup may be smaller. As such, according to the above configuration, the volume of the first scroll flow path 51 can be maximized.

Furthermore, in the above embodiment, the second scroll flow path 52 has a spiral shape. Existing turbines may have two scroll flow paths each of which fluidly communicates with a turbine impeller (so-called twin-scroll turbine). In this case, designs of the existing turbines can be easily modified to that of the present disclosure by simply modifying the design of one of the scroll flow paths.

Furthermore, in the above embodiment, the turbine T includes the exhaust opening 5a located downstream of the second space S2 in the flow of the exhaust gas, and the second scroll flow path 52 is configured to face the exhaust opening 5a in the axial direction. According to such a configuration, the direction of the exhaust gas flowing from the second scroll flow path 52 into the second space S2 is directed toward the exhaust opening 5a. Accordingly, the bypass flow smoothly merges with the main flow. As such, the exhaust gas can be directed more smoothly.

Although an embodiment of the present disclosure has been described above with reference to the accompanying drawings, the present disclosure is not limited thereto. It is obvious that a person skilled in the art can conceive of various examples of variations or modifications within the scope of the claims, which are also understood to belong to the technical scope of the present disclosure.

For example, in the above embodiment, the valve V is provided at the second inlet 52b. In other words, the valve V is provided in the turbine T. In another embodiment, however, the valve V may be provided at a location that is outside the turbine T such as an exhaust manifold connecting the engine to the second inlet 52b.

What is claimed is:

1. A turbine comprising:
an impeller; and
a housing that accommodates the impeller, the housing including:
an inlet that fluidly communicates with an exhaust port of an engine;
a first space that accommodates the impeller;
a second space that is located downstream of the first space in a flow of exhaust gas from the engine;
a first flow path that connects the inlet to the first space; and
a second flow path that directly connects the inlet to the second space without connecting the inlet to the first space.

2. The turbine according to claim 1, comprising a valve that opens and closes the second flow path at a position upstream of the first space.

3. The turbine according to claim 1, wherein the volume of the second flow path is smaller than the volume of the first flow path.

4. The turbine according to claim 1, wherein the second flow path has a spiral shape.

5. The turbine according to claim 1, comprising an exhaust opening located downstream of the second space in the flow of the exhaust gas,
wherein the second flow path is configured to face the exhaust opening in an axial direction of the impeller.
